(19) United States
(12) Patent Application Publication
(10) Pub. No.: US 2024/0232870 A9
(43) Pub. Date: Jul. 11, 2024

(54) DYNAMIC WALLET ARCHITECTURE FOR DECENTRALIZED APPLICATIONS

(71) Applicant: ATMTA, Inc., Las Vegas, NV (US)

(72) Inventors: Michael CAIN, Encino, CA (US); Jacob A. FLOYD, Peyton, CO (US); Csaba MADAR, Targu Secuiesc (RO); Pablo I. QUIROGA, Miami, FL (US); Harrison J. WHITAKER, Los Angeles, CA (US)

(21) Appl. No.: 18/490,191

(22) Filed: Oct. 19, 2023

Related U.S. Application Data
(60) Provisional application No. 63/380,104, filed on Oct. 19, 2022.

(51) Int. Cl. G06Q 20/38; G06Q 20/36

(52) U.S. Cl. CPC G06Q 20/3825; G06Q 20/36; G06Q 20/3829; G06Q 20/389

(57) ABSTRACT

Techniques relating to a decentralized application are disclosed. The techniques include enabling automatic interaction with a decentralized application relating to a blockchain, including associating a hot wallet with the decentralized application. The techniques further include performing an automatic interaction with the decentralized application using the hot wallet, including automatically signing a transaction for the blockchain using the hot wallet without associated interaction by a user of the decentralized application. The techniques further include disabling automatic interaction with the blockchain for the decentralized application including disassociating the hot wallet with the decentralized application.

### CROSS-REFERENCE TO RELATED APPLICATIONS

This application claims the benefit of and priority to U.S. Provisional Patent Application No. 63/380,104, filed on Oct. 19, 2022, the entire contents of which are incorporated herein by reference.

### INTRODUCTION

Multi-user software applications typically rely on centralized control. A developer or publisher, or another controlling entity, maintains a collection of servers to control and manage use of the application. Users login to the servers to use the application and the controlling entity manages interaction with the application for connected users. But this centralized control has numerous disadvantages, including limiting scalability, creating centralized potential points of failure, and limiting the ability of third party extensions and improvements to the application. Decentralized applications can use a blockchain to decentralize control and alleviate many of these problems, but decentralized applications can themselves have challenges. In particular, it can be challenging to securely, and seamlessly, fund use of a decentralized application by a user from assets maintained by a user in the user's wallet (e.g., funding transaction fees or providing blockchain assets for use by the application).

### SUMMARY

Embodiments include a computer-implemented method. The method includes enabling automatic interaction with a decentralized application relating to a blockchain, including associating a hot wallet with the decentralized application. The method further includes performing an automatic interaction with the decentralized application using the hot wallet, including automatically signing a transaction for the blockchain using the hot wallet without associated interaction by a user of the decentralized application. The method further includes disabling automatic interaction with the blockchain for the decentralized application, including disassociating the hot wallet with the decentralized application.

Embodiments further include a system including one or more processors and one or more memories storing a program, which, when executed on any combination of the one or more processors, performs operations. The operations include enabling automatic interaction with a decentralized application relating to a blockchain, including associating a hot wallet with the decentralized application. The operations further include performing an automatic interaction with the decentralized application using the hot wallet, including automatically signing a transaction for the blockchain using the hot wallet without associated interaction by a user of the decentralized application. The operations further include disabling automatic interaction with the blockchain for the decentralized application, including disassociating the hot wallet with the decentralized application.

Embodiments further include a non-transitory computer-readable medium containing computer program code that, when executed by operation of one or more computer processors, performs operations. The operations include enabling automatic interaction with a decentralized application relating to a blockchain, including associating a hot wallet with the decentralized application. The operations further include performing an automatic interaction with the decentralized application using the hot wallet, including automatically signing a transaction for the blockchain using the hot wallet without associated interaction by a user of the decentralized application. The operations further include disabling automatic interaction with the blockchain for the decentralized application, including disassociating the hot wallet with the decentralized application.

### DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 depicts a computing environment for a dynamic wallet architecture for a decentralized application, according to one embodiment.

FIG. 2 depicts a block diagram for a computing device as part of a dynamic wallet architecture for a decentralized application, according to one embodiment.

FIG. 3 is a flowchart illustrating a dynamic wallet architecture for a decentralized application, according to one embodiment.

FIG. 4 is a flowchart illustrating initializing automatic blockchain interactions for a dynamic wallet architecture for a decentralized application, according to one embodiment.

FIG. 5 is a flowchart illustrating identifying active sessions for a dynamic wallet architecture for a decentralized application, according to one embodiment.

FIG. 6 is a flowchart illustrating using a safelist for a dynamic wallet architecture for a decentralized application, according to one embodiment.

FIG. 7 is a flowchart illustrating using auto-sign for a dynamic wallet architecture for a decentralized application, according to one embodiment.

FIG. 8 is a flowchart illustrating connecting a wallet to an application for a dynamic wallet architecture for a decentralized application, according to one embodiment.

FIG. 9 is a flowchart illustrating auto-signing for an application event a dynamic wallet architecture for a decentralized application, according to one embodiment.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and non-transitory computer-readable mediums for a dynamic wallet architecture for a decentralized application. As discussed above, traditional multi-user applications rely on centralized control. In an embodiment, this can be improved by instead using blockchain technology to allow decentralized control and management of an application.

In an embodiment, a blockchain can act as a decentralized, immutable database that is secured by its network. Typically, the larger the network the more secure it is. For example, because data stored on a blockchain is immutable and decentralized, the data can be used to represent a digital form of a tangible asset. Assets owned on a blockchain therefore typically cannot be replicated or destroyed. This makes non-fungible tokens (NFTs), and crypto-currencies common use cases for blockchain managed data.

As discussed further herein, blockchains can further be used to implement a de-centralized application, in which application interactions are recorded on a blockchain (e.g., in real-time, or near real-time). Non-fungible, or semi-fungible, blockchain units can be used to represent assets in the decentralized application (e.g., NFTs), and software code used to manage and control the application can be stored on the blockchain. Use of decentralized applications can have numerous technical advantages, including eliminating central points of failure, improving scalability, and providing for improved security, among other advantages.

One potential challenge, however, is providing blockchain assets for use by the distributed application (e.g., cryptocurrency for use in paying transaction fees or in-application purchases, or NFTs for use as assets in the application). For example, writing to a blockchain commonly requires a transaction fee (e.g., a gas fee), which is typically paid using a cryptocurrency associated with the blockchain. Thus, use of a decentralized application may require a user to pay transaction fees as the user engages with the application.

In an embodiment, these transaction fees are relatively small (e.g., fractions of a penny) and can be paid by a user from the user's existing blockchain assets (e.g., cryptocurrency holdings) or from blockchain assets provided by a developer of the distributed application. The blockchain assets can be stored in a blockchain wallet (e.g., private encryption keys associated with the assets can be stored in the wallet), and the distributed application can use funds from the wallets to complete blockchain transactions (e.g., pay gas fees). Similarly, a user may wish to have access to certain blockchain assets (e.g., NFTs) while using an application (e.g., game items for a game application). These assets need to be made available from the user's blockchain wallet to the distributed application, to allow the user to use the assets in the distributed application.

But paying these fees, or providing blockchain assets, would typically require a user to manually agree to sign each blockchain transaction, in order to complete the transaction. This provides for an extremely undesirable user experience, potentially requiring the user to manually sign many, many transactions and wasting the user's time and attention. The user experience becomes particularly undesirable in use cases like gaming, or other blockchain applications which are used extensively with numerous transactions or smart contract interactions.

In an embodiment, this can be alleviated using one or more techniques described herein. For example, a user could be provided with auto-sign functionality that would seamlessly, and automatically, sign transactions on behalf of the user. This would greatly improve the user experience. But use of auto-sign could create potential security risks for a user. For example, a distributed application would have access to the user's blockchain wallet, in order to retrieve and pay the required fees or retrieve NFTs or other blockchain assets. This could potentially expose all of the user's assets to a distributed application, which may be undesirable. For example a malfunctioning, or malicious, distributed application could retrieve all the assets from the user's blockchain wallet and auto-sign for transfer of those assets to another wallet.

One or more techniques disclosed herein alleviate these security concerns by using temporary hot wallets as intermediaries between the user's permanent cold wallet and a distributed application. As discussed further below, one or more hot wallets can be created if security conditions are met. These security conditions can include a check that the user is actively engaged in a session with the distributed application, a check that the distributed application resources being accessed (e.g., one or more smart contracts) are included in a safelist of vetted resources, and any other suitable conditions. If conditions are sufficiently secure, a hot wallet can be created and populated only with assets needed by a user during a distributed application session. The hot wallet can then be used to provide assets to the distributed application (e.g., cryptocurrency for transaction fees or in-application purchases, blockchain assets including NFTs, and any other suitable assets). Use of a hot wallet significantly minimizes the security risk, by reducing the potential user assets exposed to malfunctioning or malicious distributed applications.

In an embodiment, this has numerous technical advantages. For example, use of distributed applications provides technical advantages over centralized applications, but can create some additional technical problems. As one example, completing blockchain transactions for a distributed application using cryptocurrency funds from a user's blockchain wallet creates significant security concerns. A malfunctioning or malicious distributed application could improperly retrieve funds from the users' wallet.

One or more techniques disclosed herein solve these technical problems by using a temporary hot wallet as an intermediary between a user's permanent cold wallet and the distributed application. This allows for seamless, and fast, transactions by the user while significantly reducing security risks. Further, one or more techniques disclosed herein provide for various additional security safeguards, including checking for an active user session and checking that distributed application resources are maintained in a vetted safelist. These provide additional technical advantages by improving security.

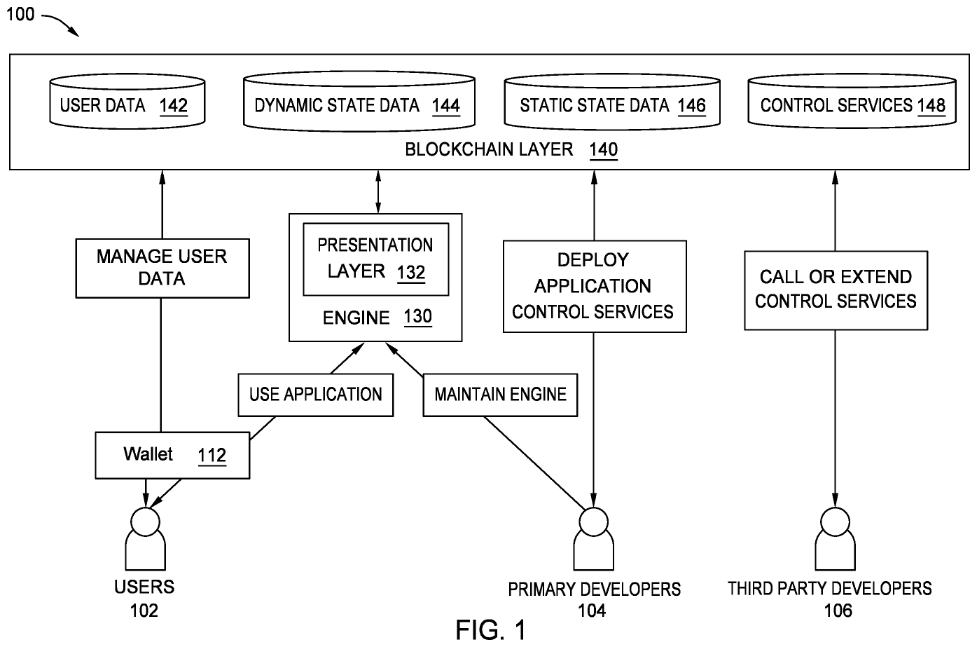

FIG. 1 depicts a computing environment 100 for a dynamic wallet architecture for a decentralized application, according to one embodiment. In an embodiment, one or more users 102 interact with a decentralized application (e.g., a massively multiplayer online game (MMO)) using a wallet 112 and an engine 130. For example, the engine 130 can present graphics to one or more of the users 102 (e.g., using a presentation layer 132) based on information stored in a blockchain layer 140, allowing the user(s) to interact with the application. While an MMO is an example of a suitable decentralized application, it is merely an example. One or more of the techniques disclosed herein can be applied to any suitable decentralized application.

As illustrated, both application state data and application control software code are stored in the blockchain layer 140. In an embodiment, control services 148 can be software code stored in the blockchain layer 140 and used to control the application (e.g., to control gameplay), while dynamic state data 144 and static state data 146 can be state data stored in the blockchain layer 140 and used to record application assets and state. For example, the blockchain layer 140 can use the Solana™ blockchain. The control services 148 can be programs deployed on the Solana™ blockchain and the dynamic state data 144 and static state data 146 can be data stored on the Solana™ blockchain. This is merely an example, and the blockchain layer 140 can use any suitable blockchain (e.g., the Ethereum® blockchain or any other suitable blockchain) or any combination of blockchains (e.g., different blockchains can be used to implement different aspects of the blockchain layer 140).

In an embodiment, the control services 148 can be deployed by one or more primary developers 104 onto the blockchain layer 140 (e.g., onto the Solana™ blockchain) and can be accessed by a variety of clients, including the users 102 (e.g., using the wallet 112), the engine 130, and third party developers 106. For example, the engine 130 can interact with the control services 148 in the blockchain layer 140 to control presentation of graphics (e.g., using the presentation layer 132). In this example, the presentation layer 132 can implement a suitable presentation engine (e.g., the Unreal Engine@ for a game). The presentation layer 132 can be deployed in a user's local computing environment (e.g., on a computing device local to the user 102), and can interact with back-end functionality maintained in the blockchain layer 140 (e.g., using the control services 148).

The engine 130 can transmit requests to the control services 148 (e.g., using the JavaScript Object Notation Remote Procedure Call (JSON-RPC) protocol, or any other suitable RPC protocol or other suitable technique) for information about the application state. The control services 148 can access state data stored in the blockchain layer 140 (e.g., dynamic state data 144 and static state data 146) and can respond to the engine 130 with the state data. The presentation layer 132 (e.g., an Unreal Engine® implementation) can then render a suitable graphical interface for the application, using the application state data. The presentation layer 132 can be any suitable graphical implementation, including a two-dimensional graphical engine, a three-dimensional graphical engine, an augmented reality graphic engine, a virtual reality graphical engine, or any other suitable graphical engine.

As another example, one or more users 102 can access the blockchain layer 140 through a respective wallet 112 to store and retrieve user data 142. For example, the blockchain layer 140 can include tokens that have value outside of the application experience. This can include NFTs (e.g., corresponding to items, images or videos related to the application, or any other suitable items) or semi-fungible tokens. In an embodiment, a user 102 can retrieve these tokens from the user data 142 using the wallet 112, transfer the tokens to another entity, or otherwise manage the tokens, using the wallet 112. For example, items in a gameplay environment (e.g., spaceships, cargo items, and any other suitable items) can be represented using tokens (e.g., NFTs or semi-fungible tokens). These tokens can be stored in the blockchain layer 140 as user data 142, and used in the application environment.

As another example, the blockchain layer 140 can include currency that has value both inside the application experience and outside the application experience. In an embodiment, the users 102 can transfer ownership of this currency to a location outside the application experience (e.g., using the wallet 112) and can otherwise manage the currency in any other suitable manner. For example, the application environment can include one or more types of currency, accessible to the user 102 through the wallet 112. This can include currency for use in-application (e.g., to purchase items in-application and use in-application), and currency with value outside of the application environment (e.g., to pay transaction fees for blockchain transactions). In an embodiment, the user data 142 can include currency, and the user 102 can withdraw currency from the application environment (e.g., to use outside of the application environment), transfer currency to others within or outside of the application environment, add currency to the application environment, or manage the user data 142 in any other suitable manner, using the wallet 112. The transactions related to the currency are recorded in the blockchain layer 140.

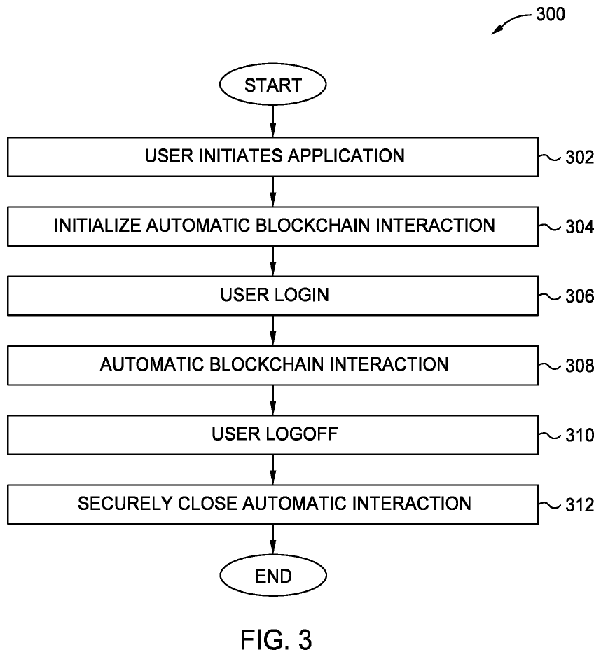

In an embodiment, the wallet 112 can be a hardware wallet, a software wallet, or any other suitable wallet. Completing transactions between the wallet 112 and the blockchain layer 140 would typically require a user 102 to manually authorize transactions (e.g., manually sign) between the wallet 112 and the blockchain layer 140. As discussed further, below, with regard to FIGS. 3-9, completing transactions can be significantly improved by using auto-sign features with a hot wallet, when secure and appropriate. For example, as discussed further below with regard to FIG. 3, assets from the wallet 112 can be temporarily maintained in a hot wallet, and auto-signature features can be implemented to allow for automatic interaction between the hot wallet and the blockchain layer 140.

In an embodiment, one or more primary developers 104 maintain the engine 130 and deploy control services 148. That is, as described above, the third party developers 106 can extend control services 148 (e.g., to add additional features, modify features, remove features, or take any other suitable action). In this embodiment only the primary developers 104, however, can deploy the control services 148 and maintain the engine 130. This allows a minimal amount of centralized control to ensure security, fairness, and other application characteristics, while allowing for highly extensible and scalable application usage (e.g., using the blockchain layer 140).

For example, the primary developers 104 can maintain suitable authentication keys, off-chain, and can use the keys to manage authorities and control changes to the control services 148. But the primary developers 104 can allow third party developers 106 to call the control services 148, without modifying the control services 148. Further, the software code used to implement the control services 148 is recorded in the blockchain layer 140, allowing the third party developers 106 to access and extend the control services. Third party developers 106 can create their own software code extending the control services 148, and can record their extended programs in the blockchain. Thus, third party developers 106 can create their own extended implementations of application functions (e.g., adding features, modifying features, or any other suitable extended implementation) based on the transparent and distributed access to the control services 148 through the blockchain layer 140, without risk that the control services 148 will themselves be modified or broken. Further, third party developers 106 can deploy their extended code (e.g., with new features) on the blockchain layer 140 to allow for ready access by the users 102.

In an embodiment, the various elements of the computing environment (e.g., any, or all, of the users 102, primary developers 104, third party developers 106, engine 130, and blockchain layer 140) interact using a suitable communication network and suitable computing devices (e.g., server computers, cloud computing nodes, laptop computers, desktop computers, smartphones, tablet computers, smart watches and wearable devices, head mounted displays, embedded devices, and any other suitable computing devices). For example, the users 102 can interact with the engine 130 and the blockchain layer 140 using a local area network (LAN), a wide area network (WAN), the Internet, or any other suitable communication network. Further, the various elements of the computing environment (e.g., any, or all, of the users 102, primary developers 104, third party developers 106, engine 130, and blockchain layer 140) can be connected to the communication network using any suitable network connection, including a wired connection (e.g., an Ethernet or fiber optic connection), a wireless connection (e.g., a WiFi connection), a cellular connection, or any other suitable network connection.

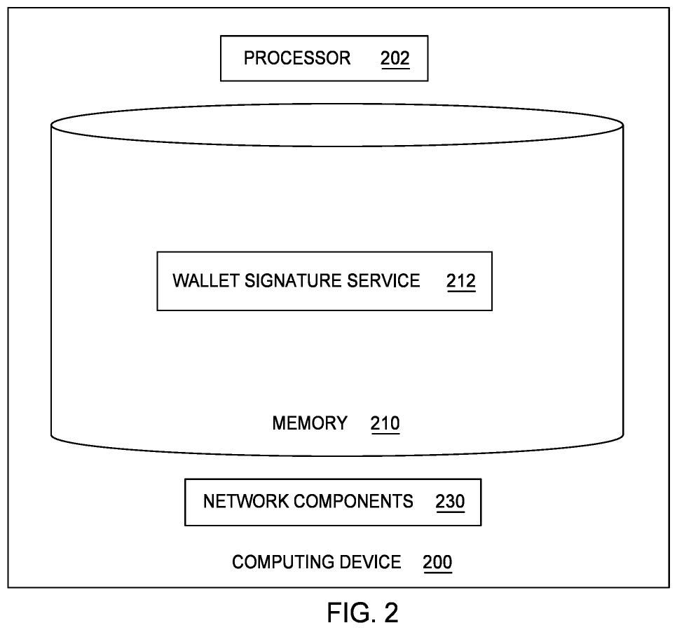

FIG. 2 depicts a block diagram for a computing device as part of a dynamic wallet architecture for a decentralized application, according to one embodiment. In an embodiment, the computing device 200 corresponds with one or more aspects of the engine 130 illustrated in FIG. 1. The computing device 200 includes a processor 202, a memory 210, and network components 230. The memory 210 may take the form of any non-transitory computer-readable medium. The processor 202 generally retrieves and executes programming instructions stored in the memory 210. The processor 202 is representative of a single central processing unit (CPU), multiple CPUs, a single CPU having multiple processing cores, graphics processing units (GPUs) having multiple execution paths, and the like.

The network components 230 include the components necessary for the computing device 200 to interface with a suitable communication network (e.g., a communication network interconnecting various components of the computing environment 100 illustrated in FIG. 1, or interconnecting the computing environment 100 with other computing systems). For example, the network components 230 can include wired, WiFi, or cellular network interface components and associated software. Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory.

The memory 210 generally includes program code for performing various functions related to use of the computing device 200. The program code is generally described as various functional “applications” or “modules” within the memory 210, although alternate implementations may have different functions and/or combinations of functions.

Within the memory 210, a wallet signature service 212 facilitates creating and populating a hot wallet and enabling auto-sign for a decentralized application, when appropriate. This is discussed further, below, with regard to FIGS. 3-9.

While the computing device 200 is illustrated as a single entity, in an embodiment, the various components can be implemented using any suitable combination of physical compute systems, cloud compute nodes and storage locations, or any other suitable implementation. For example, the computing device 200 could be implemented to operate on a user's local computing device. As another example, the computing device 200 could be implemented using a server or cluster of servers, or using a combination of compute nodes and storage locations in a suitable cloud environment. For example, one or more of the components of the computing device 200 can be implemented using a public cloud, a private cloud, a hybrid cloud, or any other suitable implementation.

Although FIG. 2 depicts the service 212 as being located in memory 210, that representation is also merely provided as an illustration for clarity. More generally, the computing device 200 may include one or more computing platforms, such as computer servers for example, which may be co-located, or may form an interactively linked but distributed system, such as a cloud-based system. As a result, processor 202 and memory 210 may correspond to distributed processor and memory resources within the computing environment 100. Thus, it is to be understood that any, or all, aspects of the service 212 may be stored remotely from one another within the distributed memory resources of the computing environment 100.

FIG. 3 is a flowchart 300 illustrating a dynamic wallet architecture for a decentralized application, according to one embodiment. At block 302, a user (e.g., a user 102 illustrated in FIG. 1) initiates a decentralized application (e.g., an application running in the blockchain layer 140 illustrated in FIG. 1). For example, the user can visit a website address (e.g., a uniform resource locator (URL) address or any other suitable website address) using a suitable web browser, to initiate the decentralized application. As another example, the user can initiate the decentralized application through a locally stored file, collection of files, link, or using any other suitable technique. In an embodiment, the user is not yet logged in to the decentralized application, prior to initiating the decentralized application.

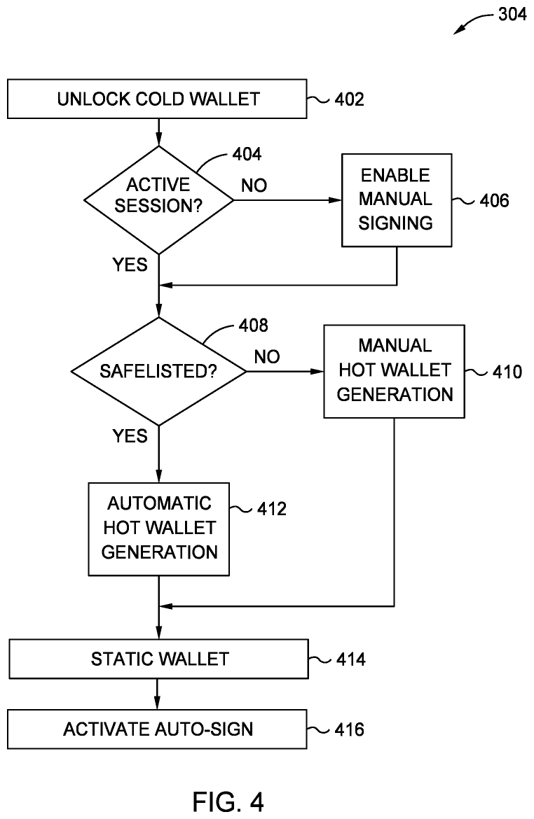

At block 304, a wallet signature service (e.g., the wallet signature service 212 illustrated in FIG. 2) initializes automatic blockchain interaction. This is discussed further, below, with regard to FIG. 4. In an embodiment, the wallet signature service determines whether automatic interaction (e.g., auto-sign for transactions and any other suitable automatic interaction) should be permitted for the user and decentralized application, and if so it activates automatic interactions between a user wallet and the decentralized application.

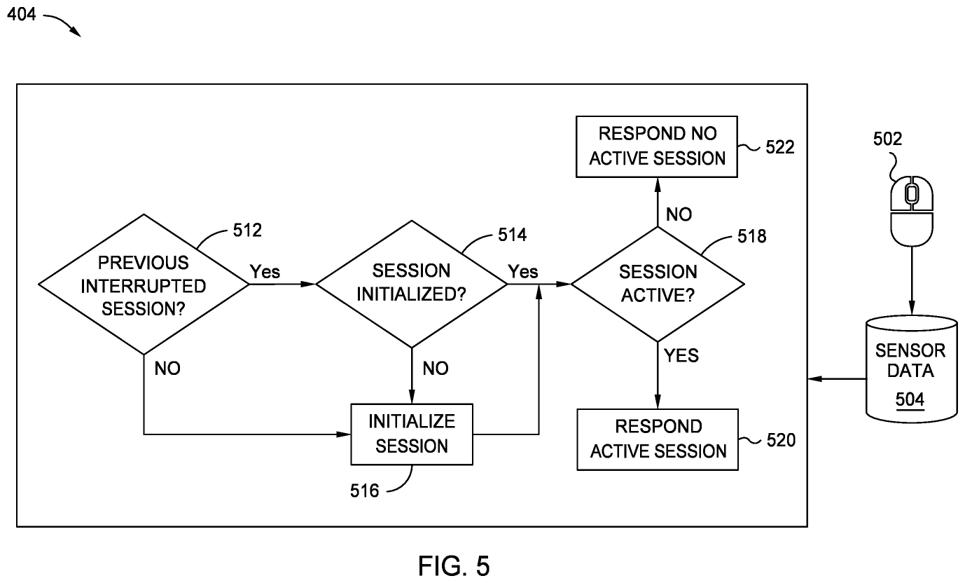

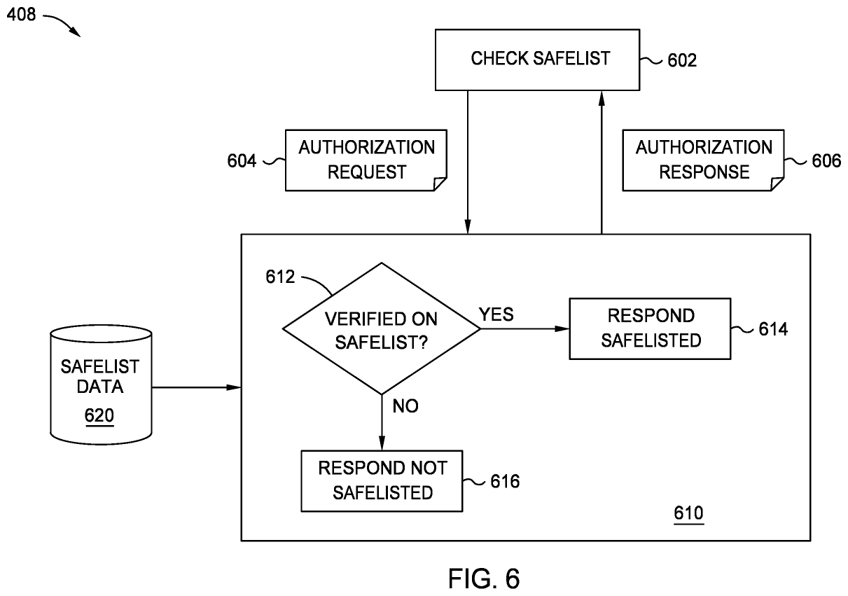

For example, a user could maintain a cold wallet (e.g., a hardware or software wallet disconnected from the Internet or other communication networks) to store private encryption keys for blockchain related assets (e.g., cryptocurrency, NFTs, and any other suitable blockchain related assets). The wallet signature service can unlock this cold wallet, create a hot wallet to use for auto-signatures from the cold wallet (e.g., a temporary software wallet populated with assets needed for operation of the decentralized application), and activate auto-sign for the decentralized application from the hot wallet. Further, the decentralized application can ensure that auto-sign is secure by checking for active user sessions (e.g., as discussed further below with regard to FIG. 5) and checking whether the decentralized application resources are included in a suitable safelist (e.g., as discussed further below with regard to FIG. 6).

At block 306 the user logs in to the decentralized application. For example, the user can input a username and password to log in to the decentralized application, can use a biometric identifier to log in (e.g., a fingerprint or retinal scanner), can use a key to log in to the decentralized application (e.g., a hardware or software key), or can log in using any suitable technique. These are merely examples.

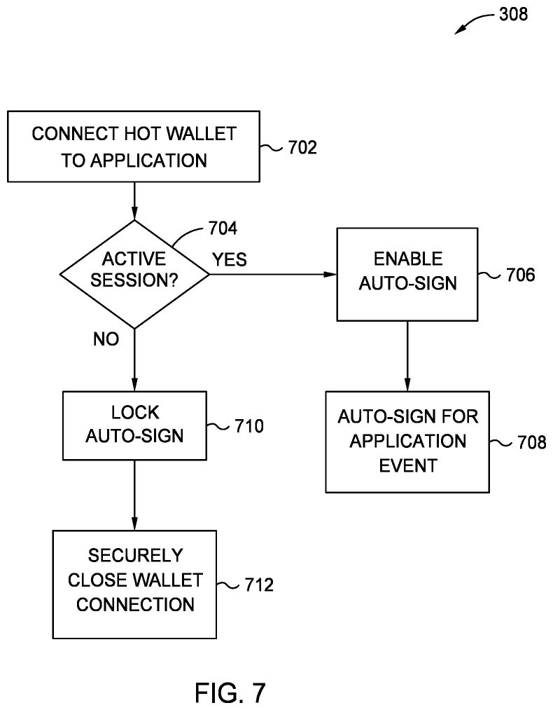

At block 308 the wallet signature service uses automatic blockchain interaction for the decentralized application, if appropriate. This is discussed further, below, with regard to FIG. 7. For example, the wallet signature service can connect the hot wallet (e.g., the temporary software wallet discussed above and further below with regard to FIG. 4) to the decentralized application and continuously monitor the user to ensure that a session with the decentralized application remains active. While the session remains active, the wallet signature service can provide auto-sign features for the decentralized application (e.g., from the hot wallet).

At block 310, the user logs off. For example, the user can choose to log out of the decentralized application. As another example, the user can automatically log off from the decentralized application. These are merely examples.

At block 312, the wallet signature service securely closes automatic interactions. For example, the wallet signature service can lock auto-sign so that it can no longer be used for the decentralized application and the hot wallet. The wallet signature service can further move remaining assets from the hot wallet back to the cold wallet, and return any rents (e.g., cryptocurrency rents) for the hot wallet back to the cold wallet. For example, some blockchain accounts (e.g., the Solana™ blockchain) may have owner-controlled state that is separate from the account's balance. Because validators on the network need to maintain a working copy of this state in memory, the network charges a time-and-space based fee for this resource consumption, commonly referred to as rent. As noted above, the wallet signature service can returns these rents from the hot wallet back to the cold wallet.

FIG. 4 is a flowchart illustrating initializing automatic blockchain interactions for a dynamic wallet architecture for a decentralized application, according to one embodiment. In an embodiment, FIG. 4 corresponds with block 304, illustrated in FIG. 3. At block 402, a user unlocks a cold wallet. As discussed above in relation to FIG. 3, in an embodiment, a cold wallet is used by a user to store private encryption keys for blockchain assets (e.g., cryptocurrency, NFTs, or any other suitable assets). The cold wallet can be a suitable hardware wallet or software wallet. Further, in an embodiment, the cold wallet is not connected to the Internet or any other communication network (e.g., not continuously connected to the Internet). This helps to ensure the security of the private keys stored on the cold wallet. The user can unlock the cold wallet using a passphrase, pin number, biometric identifier, or any other suitable technique.

At block 404 a wallet signature service (e.g., the wallet signature service 212 illustrated in FIG. 2) checks for an active session. This is discussed further, below, with regard to FIG. 5. In an embodiment, the wallet signature service checks whether the user is actively using the decentralized application. For example, the wallet signature service can receive sensor data from a suitable sensor device (e.g., a computer mouse, keyboard, movement tracker, or any other suitable sensor device) that indicates whether the user is actively using the decentralized application. Further, the wallet signature service can determine whether a prior session exists and was interrupted, and can initialize a new session.

If the wallet signature service determines that no active session exists for the user and the decentralized application (e.g., the user is not actively using the decentralized application), the flow proceeds to block 406. At block 406, the wallet signature service enables manual signing. In an embodiment, manual signing requires that a user manually authorizes blockchain transactions relating to initializing automatic blockchain interaction. For example, when the user does not have an active session, the wallet signature service can require that the user manually authorize transactions to transfer assets from the user's cold wallet to the hot wallet. This can improve security by requiring manual authorization to proceed to block 408 (e.g., to eventually populate the hot wallet), if the user does not have an active session. If the user has an active session (e.g., block 404 is true), then the wallet signature service can proceed to block 408 without requiring manual authorization.

The flow then proceeds to block 408. At block 408 the wallet signature service determines whether the decentralized application is safelisted. This is discussed further, below, with regard to FIG. 6. In an embodiment, the wallet signature service accesses a safelist of vetted, safe, resources. These entries can include URLs, domain names, smart contract identifiers, and any other suitable resources. The safelist can enable expanded features for interactions with these safelisted resources, including enabling auto-sign.

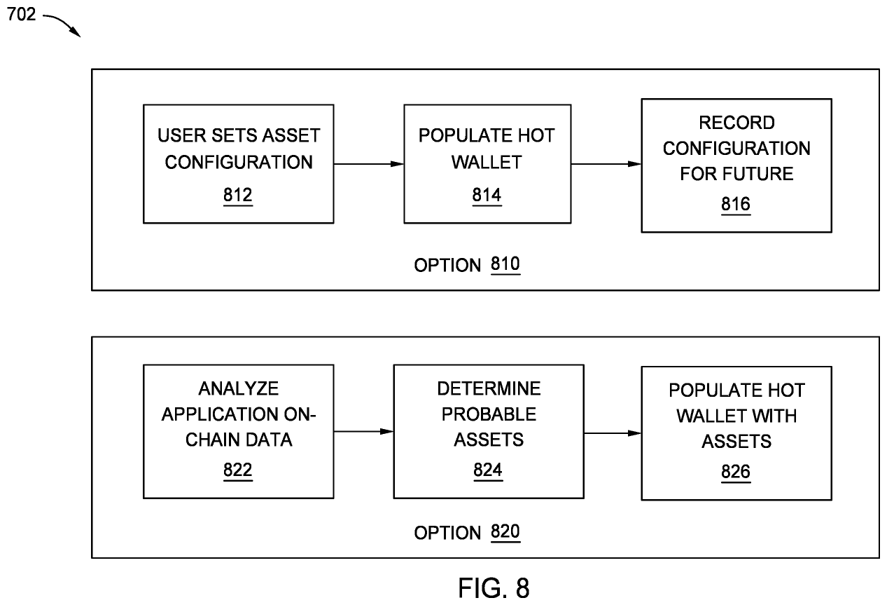

In an embodiment, if a resource (e.g., a URL, domain name, or smart contract) being accessed by the user is safelisted, the flow proceeds to block 412 and the wallet signature service enables automatic hot wallet generation. For example, the wallet signature service can automatically generate or identify a hot wallet to use for automated features. As discussed further below with regard to FIGS. 7-8, the wallet signature service can fund the hot wallet with suitable assets for use by the user while interacting with the decentralized application. These assets can include cryptocurrency used to interact with the decentralized application (e.g., cryptocurrency used to pay transaction fees), other blockchain assets (e.g., NFTs) for use with the decentralized application, and any other suitable assets. If the resource being accessed is safelisted, the wallet signature service can automatically populate the hot wallet with assets.

By contrast, if the entry being accessed by the user is not safelisted, the flow proceeds to block 410 and the wallet signature service enables manual hot wallet generation. For example, the wallet signature service can require manual authorization to populate the hot wallet with assets (e.g., from the user's cold wallet). As another example, the wallet signature service can query the user and allow the user to expressly enable automatic hot wallet generation (e.g., auto-sign for transferring assets from the cold wallet to the hot wallet). This query, and the manual authorization discussed above in relation to blocks 406 and 410, can be performed through a suitable user interface (e.g., a graphical user interface, a textual user interface, a voice interface, a virtual reality or augmented reality interface, or any other suitable user interface).

At block 416, the wallet signature service activates auto-sign. In an embodiment, the wallet signature service uses a static wallet 414 as an intermediary between a hot wallet (e.g., a hot wallet generated at block 412 above) and a decentralized application. For example, the wallet signature service may repeatedly create, and destroy, hot wallets as a user begins and ends active sessions with the decentralized application. The static wallet 414 can be used to persistently identify the user, across multiple hot wallets. Thus, the wallet signature service can connect the hot wallet to the static wallet 414, and the static wallet 414 to the decentralized application, to allow for automatic interaction with the decentralized application by the user and persistent identification of the user. In an embodiment, the static wallet 414 further holds private encryption keys relating to blockchain assets. Alternatively, the static wallet 414 acts as an intermediary between the hot wallet and the decentralized application but does not itself hold assets.

In an embodiment, auto-sign allows a user to automatically sign blockchain transactions between the hot wallet and the decentralized application. For example, the decentralized application may institute transactions that require transaction fees. The wallet signature service can automatically sign to allow suitable cryptocurrency (e.g., a minimal amount of cryptocurrency authorized by the user, as discussed further below with regard to FIG. 8) to be used from the hot wallet to pay the required fees. As another example, the decentralized application may require blockchain assets (e.g., NFTs). For example, an MMO game decentralized application may include various game assets (e.g., vehicles, weapons, skins, and any other suitable assets) that can be maintained as NFTs stored in the blockchain. These assets can be populated to the hot wallet (e.g., as discussed below with regard to FIG. 7) and the wallet signature service can auto-sign transactions in the decentralized application using these assets (e.g., changing properties or characteristics of the assets).

Further, in an embodiment, auto-sign can be configured to act differently for different scenarios. For example, the wallet signature service can require user approval in some circumstances, or require different levels of approval for different circumstances. In this example auto-sign could act differently for asset trades (e.g., requiring no or less approval) than for transactions in which an asset leaves the wallet (e.g., requiring more approval). Further, safelisted decentralized application resources can have a different auto-sign configuration (e.g., requiring less approval) compared to non-safelisted decentralized application resources (e.g., application resources which are not safelisted but for which a user has manually enabled auto-sign). In an embodiment, auto-sign can be enabled by default or disabled by default, and can (if desired) allow a user to manually toggle between auto-sign being enabled or disabled (e.g., using a suitable user interface). Further, in an embodiment, the user can configure whether an active session and safelisted resource are required to enable automatic hot wallet generation, as discussed above in relation to blocks 406 and 410.

FIG. 5 is a flowchart illustrating identifying active sessions for a dynamic wallet architecture for a decentralized application, according to one embodiment. In an embodiment, FIG. 5 corresponds with block 404 illustrated in FIG. 4. At block 512, a wallet signature service (e.g., the wallet signature service 212 illustrated in FIG. 2) determines whether any previous interrupted session exists for a user and decentralized application. In an embodiment, the wallet signature service maintains persistent sessions (e.g., using a suitable electronic repository). The wallet signature service can access the electronic repository to determine whether a previously interrupted session exists for the user and the decentralized application (e.g., using suitable identifiers).

If a previous interrupted session exists, the flow proceeds to block 514. At block 514 the wallet signature service determines whether the previous session was initialized (e.g., based on persistent data for the session maintained in the electronic repository). If the session was not initialized, or if no previous session was found at block 512, the flow proceeds to block 516.

At block 516 the wallet signature service initializes the session. For example, the wallet signature service can initialize the session after a user unlocks a cold wallet for interaction with the decentralized application (e.g., as discussed above in relation to block 402 illustrated in FIG. 4). Further, the wallet signature service can generate data describing the session, and record the data in an electronic repository to keep the session persistent. The flow then proceeds to block 518.

At block 518, the wallet signature service determines whether the session is active. For example, the wallet signature service can use sensor data 504 from a sensor device 502 to determine whether the session is active. In an embodiment, the sensor device 502 is a hardware device that can be used to identify whether a user is actively engaged with the decentralized application. For example, the sensor device 502 can be a computer mouse, a game controller, a keyboard, a touch sensitive device, a voice controlled device, a movement sensing device (e.g., an armband, watch, or other suitable movement sensing device), or any other suitable device. The sensor data 504 can describe whether the sensor device 502 is actively being used with the session. If the wallet signature service determines that the session is not active, then it responds with no active session 522. If the wallet signature service determines that the session is active, then it responds with active session 520. In an embodiment, the sensor data 504 is sampled at a rate in which user activity can be extrapolated, in order to measure whether a session remains active and persistent.

As one example, the sensor device 502 can be a computer mouse. The sensor data 504 can record movement of the mouse. If the mouse remains stationary for a sufficient length of time (e.g., a defined threshold time duration) then the wallet control service assumes that the user is not actively engaged with the decentralized application and responds no active session 522. If the mouse is moved sufficiently frequently, then the wallet control service assumes that the user is actively engaged with the decentralized application and responds active session 522.

In an embodiment, the sensor device 502 can further be integrated with a cold wallet, and interaction with the sensor device 502 can be used to unlock the cold wallet. For example, the sensor device 502 can, itself, be a cold wallet storing private encryption key values for user blockchain assets, or the sensor device 502 can be associated with a cold wallet. Interaction with the sensor device 502 can unlock the cold wallet (e.g., entry of a passphrase or biometric identifier). This is merely an example, and the sensor device 502 can also be separate from the cold wallet.

FIG. 6 is a flowchart illustrating using a safelist for a dynamic wallet architecture for a decentralized application, according to one embodiment. In an embodiment, FIG. 6 corresponds with block 408 illustrated in FIG. 4, above. At block 602, a wallet signature service (e.g., the wallet signature service 212 illustrated in FIG. 2) checks a safelist. In an embodiment, the wallet signature service transmits an authorization request 604 to a safelist service 610. For example, the authorization request 604 can include an identifier describing a decentralized application resource (e.g., a URL, domain name, smart contract identifier, or any other suitable identifier). The safelist service 610 can be maintained on a remote server, or any other suitable computing device, and the wallet signature service can transmit the authorization request 604 to the safelist service 610 over a suitable communication network, or using any other suitable connection (e.g., a direct connection, a local connection, or any other suitable connection).

At block 612 the safelist service 610 determines whether the resource identified in the authorization request 604 is verified on the safelist. For example, the safelist service 610 can use the authorization request 604 to determine whether the resource identifier is maintained in safelist data 620. The safelist data 620 can be maintained in any suitable electronic repository, including a database, a cloud repository, a local repository, or any other suitable electronic repository. Further, the safelist data 620 can itself be maintained on a blockchain (e.g., as part of the blockchain layer 140 illustrated in FIG. 1).

As described above, in an embodiment the safelist data 620 describes decentralized applications (or aspects of decentralized applications) that have been deemed safe for user interaction (e.g., by the primary developers 104 of the decentralized application). If a user access a decentralized application resource that is included in the safelist data 620 then additional features can be enabled. This can include auto-sign, as described above in relation to block 412 illustrated in FIG. 4.

In an embodiment, if the wallet signature service determines that the resource identified in the authorization request 604 is included in the safelist data 620, the wallet signature service responds safelisted 614. For example, the wallet signature service can transmit an authorization response 606 reflecting that the authorization request 604 is for a safelisted resource. Alternatively, if the wallet signature service determines that resource identified in the authorization request 604 is not included in the safelist data 620, the wallet signature service responds not safelisted 616. For example, the wallet signature service can transmit an authorization response 606 reflecting that the authorization request 604 is for a not-safelisted resource.

FIG. 7 is a flowchart illustrating using auto-sign for a dynamic wallet architecture for a decentralized application, according to one embodiment. In an embodiment, FIG. 7 corresponds with block 308 illustrated in FIG. 3. At block 702 a wallet signature service (e.g., the wallet signature service 212 illustrated in FIG. 2) connects a hot wallet to the decentralized application. This is discussed further below with regard to FIG. 8.

For example, the wallet signature service can fund the hot wallet (e.g., a hot wallet generated as part of secure initialization at block 304 illustrated in FIG. 3) with assets from a cold wallet (e.g., the cold wallet discussed above in relation to block 402 illustrated in FIG. 4). In one embodiment, the wallet signature service funds the hot wallet automatically with assets expected to be needed by the user. Alternatively, or in addition, the wallet signature service asks the user to manually fund the hot wallet with desired assets. As another alternative, the wallet signature service can use a transaction relayer to fund the hot wallet. These are discussed further, below, with regard to FIG. 8.

At block 704, the wallet signature service checks for an active session. As discussed above in relation to FIG. 5, in an embodiment the wallet signature service enables automatic blockchain interaction (e.g., auto-sign) only while a user maintains an active session with the decentralized application. The wallet signature service can use a sensor device (e.g., the sensor device 502 illustrated in FIG. 5) and sensor data (e.g., the sensor data 504 illustrated in FIG. 5) to identify whether the user is engaged in an active session. As discussed above, in an embodiment the sensor device 502 is a hardware sensor device that generates the sensor data 504, and the sensor data 504 is sampled at a rate in which user activity can be extrapolated, in order to measure whether a session remains active and persistent.

If the session remains active, the flow proceeds to block 706. At block 706 the wallet signature service enables auto-sign. For example, the wallet signature service enables auto-sign for specified resources of the decentralized application (e.g., specified smart contracts) from the populated hot wallet. In an embodiment, auto-sign allows a user to seamlessly engage with the decentralized application, without being required to manually sign transactions associated with the application, but while maintaining the security of the user's blockchain assets.

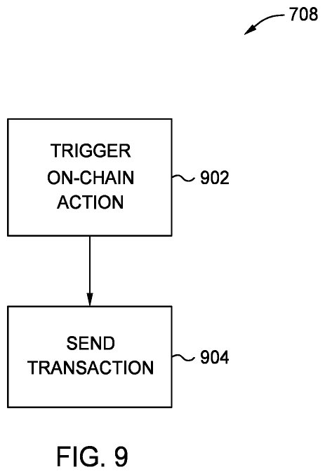

At block 708 the wallet signature service auto-signs for an application event. This is discussed further, below, with regard to FIG. 9. For example, the wallet signature service can trigger an on-chain action associated with the decentralized application (e.g., using a smart contract) and can send a signed transaction to record in the blockchain.

Returning to block 704, if the wallet signature service identifies that a session is not active, the flow proceeds to block 710. At block 710, the wallet recognition locks auto-sign. In an embodiment, this stops further user of auto-sign.

At block 712, the wallet signature service securely closes the wallet connection. As discussed above in relation to block 312 illustrated in FIG. 3, in an embodiment the wallet signature service moves any assets remaining in the hot wallet back to the user's cold wallet. The wallet signature service further returns any associated rents for the hot wallet.

FIG. 8 is a flowchart illustrating connecting a wallet to an application for a dynamic wallet architecture for a decentralized application, according to one embodiment. In an embodiment, FIG. 8 corresponds with block 702 illustrated in FIG. 7. In an embodiment, FIG. 7 illustrates two options for populating a hot wallet from a cold wallet (e.g., selecting which assets to move from a user's cold wallet to a hot wallet). An option 810 illustrates a user setting a configuration for populating the hot wallet. An option 820 illustrates automatically populating a hot wallet based on a user's expected needs. A wallet signature service (e.g., the wallet signature service 212 illustrated in FIG. 2) can implement either, or both, of these options.

In the option 810, at block 812 a user sets an asset configuration. In an embodiment, a user can configure which assets should be moved from the user's cold wallet and made available for use with the decentralized application. For example, a user can select a quantity or type of cryptocurrency to make available for transaction fees (e.g., gas fees), in-application purchases, and other uses. As another example, a user can select additional blockchain assets (e.g., NFTs) to make available in the application.

As one example, assume the decentralized application is a blockchain-implemented MMO game. The user can select cryptocurrency to make available in a hot wallet for transaction fees in the game (e.g., gas fees needed to conduct transactions in the game). The user can further select NFT items to make available in a hot wallet for use in the game (e.g., vehicles, weapons, skins, and any other suitable items). In an embodiment, the user can select assets using a suitable user interface (e.g., a graphical user interface presenting a list of assets available in the user's cold wallet, and allowing the user to select desired assets to make available in the decentralized application).

In an embodiment, the user can set the asset configuration on a per application basis. For example, the user can set the asset configuration differently for different types of decentralized applications (e.g., set a different quantity of cryptocurrency to make available for different types of applications) or for different specific applications. As discussed below in relation to block 816, the wallet signature service can maintain a record of the desired configurations for future use.

At block 814, the wallet signature service populates the hot wallet. For example, the wallet signature service can pull the selected assets from a user's cold wallet into the hot wallet. In an embodiment, this provides an initial selection of assets for the user, and reduces the need for repeated transfers of assets from the cold wallet to the hot wallet. This can reduce transaction fees (e.g., transaction fees needed to move assets between wallets) and provide a more seamless user experience (e.g., limiting wait times and prompts related to moving assets between wallets).

At block 816, the wallet signature service records the configuration for future use. In an embodiment, the user set asset configuration can be recorded. The next time the user beings using the decentralized application, the wallet signature service can use the recorded asset configuration to populate the hot wallet. For example, the wallet signature service can automatically move the previously selected assets from the cold wallet to the hot wallet, the next time the user accesses the decentralized application. As another example, the wallet signature service can pre-populate a user interface with previously selected assets to reduce the need of the user to modify the asset configuration.

Turning to the option 820, at block 822 the wallet signature service analyzes the decentralized application on-chain data. For example, the wallet signature service can identify an average (e.g., mean or median) number of transactions per time period (e.g., transactions per hour or transactions per minute) for the decentralized application and an average length of a session with the decentralized application. As another example, the wallet signature service can identify the type or number of assets commonly used with the decentralized application.

At block 824, the wallet signature service determines probable assets. In an embodiment, the wallet signature service uses the on-chain data analyzed at block 822 to determine probable assets for the user. For example, the average number of transactions and the available cryptocurrency in the user's cold wallet can be used to identify a likely quantity of cryptocurrency need by the user for transaction fees. As another example, the commonly used assets with the decentralized application can be used to identify which (if any) of the user's other assets in the cold wallet should be moved to the hot wallet.

In an embodiment, the wallet signature service uses rules (e.g., pre-defined rules) to identify the probable assets. Alternatively, or in addition, the wallet signature service uses a suitable machine learning (ML) model to predict assets. For example, an ML model can be trained with data reflecting prior assets used by users for a given decentralized application, a given type of decentralized application (e.g., MMO games generally or MMO games of a particular genre), or decentralized applications generally. The trained ML model can then be used to infer a prediction of probable assets for the user. Any suitable ML model can be used, including a neural network (e.g., a deep learning neural network (DNN), convolutional neural network (CNN), or any other suitable neural network) or any other form of supervised ML model. Further, an unsupervised ML model can be used to predict probable assets.

At block 826, the wallet signature service populates the hot wallet with assets. For example, the wallet signature service can move the probable assets identified at block 824 (e.g., the probable type and quantity of cryptocurrency, and any other assets) from a user's cold wallet to the hot wallet. This allows the seamless use of these assets, with the decentralized application, while protecting the remaining assets in the cold wallet from exposure.

In an embodiment, a hot wallet can be designed to use with a particular type of asset. For example, a particular hot wallet could be designed to use with cryptocurrency, or a specific type of cryptocurrency, while another hot wallet could be designed to use with NFTs. In an embodiment, the wallet signature service populates (and uses) multiple hot wallets for different types of assets. Alternatively, the wallet signature service populates (and uses) a single hot wallet for multiple types of assets.

In an embodiment, the options 810 and 820 are merely examples and the wallet signature service can use any suitable technique to populate the hot wallet. For example, the wallet signature service can use a transaction relayer to fund the hot wallet. In an embodiment, a transaction relayer can provide a centralized service to relay transactions from one cryptocurrency to another. For example, a decentralized application could use a specific cryptocurrency for in-application transactions (e.g., to purchase and sell items or services in the application). But another cryptocurrency could be required for transaction fees to use the decentralized application (e.g., gas fees). The user could purchase (or be provided with) the application specific cryptocurrency. The wallet signature service can populate the hot wallet with this application-specific cryptocurrency, and a transaction relayer can then swap the application-specific cryptocurrency for the different cryptocurrency needed to complete transactions in the application. This can allow the user to seamlessly use the decentralized application by populating the hot wallet with the application-specific cryptocurrency, without requiring the user to purchase a specific cryptocurrency used for the application infrastructure.

FIG. 9 is a flowchart illustrating auto-signing for an application event a dynamic wallet architecture for a decentralized application, according to one embodiment. In an embodiment, FIG. 9 corresponds with block 708 illustrated in FIG. 7. At block 902 a wallet signature service (e.g., the wallet signature service 212 illustrated in FIG. 2) triggers an on-chain action. For example, the wallet signature service can use a smart contract associated with a decentralized application to trigger an on-chain action. This is merely an example, and any suitable service (e.g., other than then wallet signature service) can trigger the on-chain action.

At block 904, the wallet signature service sends the transaction. In an embodiment, the wallet configuration auto-signs the transaction, and any required payment of transaction fees (e.g., gas fees), using a hot wallet (e.g., as described above). The wallet signature service sends the signed transaction for recording on the blockchain.

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a computer, a special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
enabling automatic interaction with a decentralized application relating to a blockchain, comprising:
associating a hot wallet with the decentralized application;
performing an automatic interaction with the decentralized application using the hot wallet, comprising:
automatically signing a transaction for the blockchain using the hot wallet without associated interaction by a user of the decentralized application; and
disabling automatic interaction with the blockchain for the decentralized application, comprising:
disassociating the hot wallet with the decentralized application.

2. The method of claim 1, wherein the hot wallet comprises a temporary wallet that acts as an intermediary between the decentralized application and a second wallet associated with one or more encryption keys for the user of the decentralized application to interact with the blockchain.

3. The method of claim 2, further comprising:
determining that the user of the decentralized application is engaged in an active session with the decentralized application, prior to enabling the automatic interaction with the decentralized application.

4. The method of claim 3, wherein determining that the user of the decentralized application is engaged in the active session with the decentralized application comprises:
determining, based on sensor data from a hardware device associated with the user, that the user is engaged in the active session with the decentralized application.

5. The method of claim 4, wherein the hardware device comprises at least one of: (i) a computer mouse, (ii) a game controller, (iii) a keyboard, (iv) a touch sensitive device, (v) a voice controlled device, or (vi) a movement sensing device.

6. The method of claim 4, wherein the hardware device is further associated with the second wallet associated with one or more encryption keys for the user of the decentralized application.

7. The method of claim 3, further comprising:
identifying an existing persistent session for the user and the decentralized application.

8. The method of claim 2, further comprising:
determining that the decentralized application is safelisted, prior to enabling the automatic interaction with the decentralized application.

9. The method of claim 2, wherein signing the transaction for the blockchain using the hot wallet further comprises:
identifying a static wallet that persistently identifies the user of the decentralized application across a plurality of hot wallets; and
signing the transaction for the blockchain using both the hot wallet and the static wallet.

10. The method of claim 2,
wherein associating the hot wallet with the decentralized application further comprises:
funding the hot wallet using the second wallet by populating the hot wallet with a first one or more blockchain assets from the second wallet, and
wherein disassociating the hot wallet with the decentralized application further comprises:
returning a second one or more blockchain assets from the hot wallet to the second wallet.

11. The method of claim 10, wherein funding the hot wallet using the second wallet by populating the hot wallet with one or more blockchain assets from the second wallet further comprises:
identifying the first one or more blockchain assets for populating the hot wallet based on data relating to the decentralized application stored on the blockchain.

12. A system, comprising:
one or more processors;
one or more memories storing a program, which, when executed on any combination of the one or more processors, performs operations, the operations comprising:
enabling automatic interaction with a decentralized application relating to a blockchain, comprising:
associating a hot wallet with the decentralized application;
performing an automatic interaction with the decentralized application using the hot wallet, comprising:
automatically signing a transaction for the blockchain using the hot wallet without associated interaction by a user of the decentralized application; and
disabling automatic interaction with the blockchain for the decentralized application, comprising:
disassociating the hot wallet with the decentralized application.

13. The system of claim 12, wherein the hot wallet comprises a temporary wallet that acts as an intermediary between the decentralized application and a second wallet associated with one or more encryption keys for the user of the decentralized application to interact with the blockchain.

14. The system of claim 13, the operations further comprising:
determining that the user of the decentralized application is engaged in an active session with the decentralized application, prior to enabling the automatic interaction with the decentralized application.

15. The system of claim 14, wherein determining that the user of the decentralized application is engaged in the active session with the decentralized application comprises:
determining, based on sensor data from a hardware device associated with the user, that the user is engaged in the active session with the decentralized application.

16. The system of claim 13, wherein signing the transaction for the blockchain using the hot wallet further comprises:
identifying a static wallet that persistently identifies the user of the decentralized application across a plurality of hot wallets; and
signing the transaction for the blockchain using both the hot wallet and the static wallet.

17. A non-transitory computer-readable medium containing computer program code that, when executed by operation of one or more computer processors, performs operations comprising:
enabling automatic interaction with a decentralized application relating to a blockchain, comprising:
associating a hot wallet with the decentralized application;
performing an automatic interaction with the decentralized application using the hot wallet, comprising:
automatically signing a transaction for the blockchain using the hot wallet without associated interaction by a user of the decentralized application; and
disabling automatic interaction with the blockchain for the decentralized application, comprising:
disassociating the hot wallet with the decentralized application.

18. The non-transitory computer-readable medium of claim 17, wherein the hot wallet comprises a temporary wallet that acts as an intermediary between the decentralized application and a second wallet associated with one or more encryption keys for the user of the decentralized application to interact with the blockchain.

19. The non-transitory computer-readable medium of claim 18, the operations further comprising:
determining that the user of the decentralized application is engaged in an active session with the decentralized application, prior to enabling the automatic interaction with the decentralized application.

20. The non-transitory computer-readable medium of claim 18, wherein signing the transaction for the blockchain using the hot wallet further comprises:
identifying a static wallet that persistently identifies the user of the decentralized application across a plurality of hot wallets; and
signing the transaction for the blockchain using both the hot wallet and the static wallet.
